(19) United States
(12) Patent Application Publication
(10) Pub. No.: US 2024/0346559 A1
(43) Pub. Date: Oct. 17, 2024

(54) ESTIMATION SYSTEM, ESTIMATION PROGRAM, AND CONTROL METHOD FOR ESTIMATION SYSTEM

(71) Applicant: MISUMI CORPORATION, Tokyo (JP)

(72) Inventors: Kazuya MURAKAMI, Tokyo (JP); Mudai SUGANO, Tokyo (JP)

(73) Assignee: MISUMI CORPORATION, Tokyo (JP)

(21) Appl. No.: 18/707,995

(22) PCT Filed: Oct. 20, 2022
(86) PCT No.: PCT/JP2022/039056

§ 371 Date: May 7, 2024

(30) Foreign Application Priority Data
Nov. 29, 2021 (JP) 2021-192896

(51) Int. Cl. G06Q 30/0283

(52) U.S. Cl. CPC G06Q 30/0283

(57) ABSTRACT

An estimation system that estimates an assembly cost of an assembly includes: an acquisition unit that acquires component specifying information for specifying components constituting the assembly from a component candidate group, and specification information for specifying a specification of the assembly constituted by the components specified by the component specifying information; and a calculation unit that calculates, by using a predetermined calculation rule, the assembly cost when assembling the assembly according to the specification specified by the specification information from each of components specified by the component specifying information. The calculation rule includes a first rule set for each component of the component candidate group and a second rule set for one of the components of the component candidate group with respect to the specification information. The second rule is set for each of specification categories classified into a plurality of specification categories according to the specification information.

### CROSS-REFERENCE TO RELATED PATENT APPLICATIONS

This application is a U.S. National Phase Application under 35 U.S.C. § 371 of International Patent Application No. PCT/JP2022/039056 filed on Oct. 20, 2022, which claims the benefit of priority to Japanese Patent Application No. 2021-192896 filed on Nov. 29, 2021, the contents of all of which are incorporated herein by reference in their entireties. The International Application was published in Japanese on Jun. 1, 2023 as International Publication No. WO2023/095499 under PCT Article 21 (2).

### FIELD OF THE INVENTION

The present invention relates to an estimation system that estimates an assembly cost of an assembly, an estimation program, and a control method for the estimation system.

### BACKGROUND OF THE INVENTION

JP 2017-068809 discloses a design support system that supports design of a structure including a plurality of members. Then, the design support system includes a storage device that stores a design support program. The design support program is a program of a CAD application that supports design of a structure on a virtual three-dimensional coordinate system. Further, the structure includes, for example, an aluminum frame, and various articles can be stored therein.

### CITATION LIST

### Patent Literature

Patent Literature 1: JP 2017-068809

### Technical Problem

When a user purchases an assembly constituted by assembling a plurality of components, an estimation considering an assembly cost of the assembly may be required. That is, when the user purchases an assembly, there is a method of purchasing a pre-assembled assembly in addition to a method of purchasing components of the assembly and assembling the assembly by the user. Then, it is desirable for the user to determine which method to employ by comparing the labor required for assembling the assembly by the user with the assembly cost. Therefore, the user may wish to estimate the assembly cost.

### SUMMARY OF THE INVENTION

### Solution to Problem

An estimation system according to an aspect of the present invention is an estimation system that estimates an assembly cost of an assembly constituted by assembling a plurality of components, the estimation system comprising an acquisition unit that acquires component specifying information for specifying components constituting the assembly from a component candidate group, and specification information for specifying a specification of the assembly constituted by the components specified by the component specifying information, and a calculation unit that calculates, by using a predetermined calculation rule, the assembly cost in a case of assembling the assembly according to the specification specified by the specification information from each of components specified by the component specifying information, wherein the calculation rule includes a first rule set for each of components of the component candidate group and a second rule set for at least one of the components of the component candidate group with respect to the specification information, and the second rule is set for each of specification categories classified into a plurality of specification categories according to the specification information.

Further, an estimation program according to an aspect of the present invention is an estimation program of an estimation system that comprises a computer and estimates an assembly cost of an assembly constituted by assembling a plurality of components, the estimation program causing the computer to function as an acquisition unit that acquires component specifying information for specifying components constituting the assembly from a component candidate group, and specification information for specifying a specification of the assembly constituted by the components specified by the component specifying information, and a calculation unit that calculates, by using a predetermined calculation rule, the assembly cost in a case of assembling the assembly according to the specification specified by the specification information from each of components specified by the component specifying information, wherein the calculation rule includes a first rule set for each of components of the component candidate group and a second rule set for at least one of the components of the component candidate group with respect to the specification information, and the second rule is set for each of specification categories classified into a plurality of specification categories according to the specification information.

Further, a control method for an estimation system according to an aspect of the present invention is a control method for an estimation system that estimates an assembly cost of an assembly constituted by assembling a plurality of components, the control method comprising acquiring component specifying information for specifying components constituting the assembly from a component candidate group, and specification information for specifying a specification of the assembly constituted by the components specified by the component specifying information, and calculating, by using a predetermined calculation rule, the assembly cost in a case of assembling the assembly according to the specification specified by the specification information from each of components specified by the component specifying information, wherein the calculation rule includes a first rule set for each of components of the component candidate group and a second rule set for at least one of the components of the component candidate group with respect to the specification information, and the second rule is set for each of specification categories classified into a plurality of specification categories according to the specification information.

### Advantageous Effects of Invention

Thus, when an assembly constituted by assembling a plurality of components is purchased, an estimation result of the assembly cost can be provided.

### BRIEF DESCRIPTION OF THE DRAWINGS

FIG. 1 is a schematic diagram for explaining an estimation system.

FIG. 2 is a schematic perspective view for explaining an assembly.

FIG. 3 is a schematic block diagram of the estimation system.

FIG. 4 is a schematic table of a first rule.

FIG. 5 is a schematic table of a second rule.

FIG. 6 is a schematic diagram illustrating an example of an estimation screen.

FIG. 7 is a schematic diagram illustrating an example of an assembly estimation screen.

FIG. 8 is a schematic diagram illustrating another example of the assembly estimation screen.

FIG. 9 is a schematic flowchart of calculation processing.

FIG. 10 is another schematic table of the first and second rules.

### DETAILED DESCRIPTION OF THE INVENTION

Hereinafter, exemplary embodiments for carrying out the present invention will be described in detail with reference to the drawings. However, the dimensions, materials, shapes, and relative positions of the components described in the following embodiments can be arbitrary set and can be changed according to the configuration of a method or an article to which the present invention is applied or to various conditions. Unless otherwise specified, the scope of the present invention is not limited to the embodiments specifically described below.

### First Embodiment

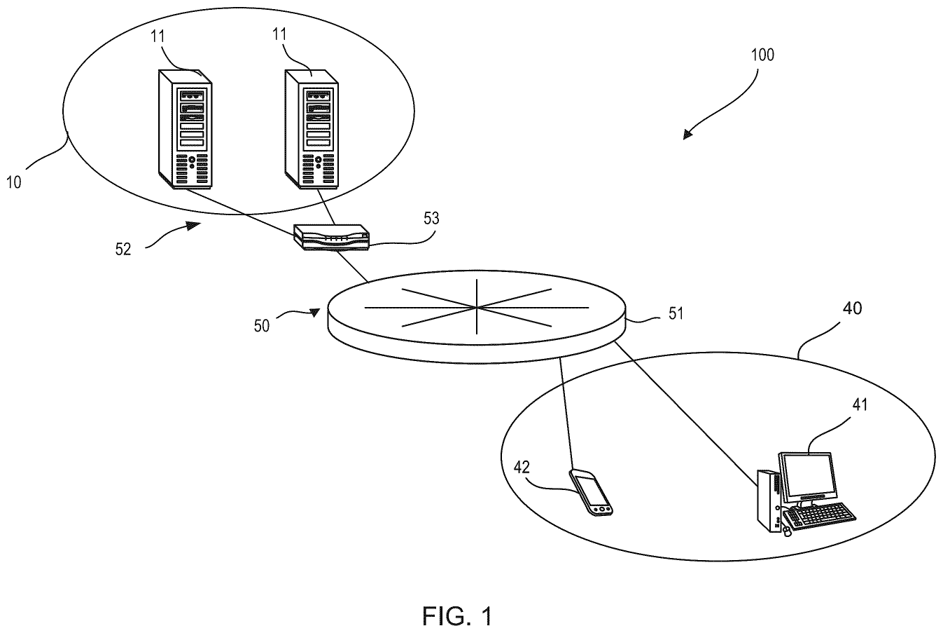

As illustrated in FIG. 1, a user terminal 40 and an estimation server 10 exist in an estimation system 100 that estimates an assembly cost of an assembly constituted by assembling a plurality of components. The user terminal 40 is managed by a user who purchases an assembly. Further, the estimation server 10 is managed by a management company such as an assembly vendor. For example, the user purchases an assembly as a product or a plurality of components constituting the assembly from the vendor. Then, the vendor procures the product from a supplier in response to a request from the user, and sells the assembly or the plurality of components to the user. As an example, the supplier is a supplier that produces, processes, sells, transports, or stores components to supply products. Incidentally, assembling of the plurality of components may be performed by the vendor or may be performed by the supplier.

The estimation system 100 is configured as a network system or a client server system including an estimation server 10. The estimation server 10 functions as a server device, and is configured as one logical server device by combining, for example, server units 11 as a plurality of computer devices. However, the estimation server 10 may be configured by a single server unit 11. Alternatively, the estimation server 10 may be logically configured by using cloud computing.

The estimation server 10 provides the user terminal 40 or the user of the user terminal 40 with various services including a product estimation service and an ordering service. The estimation service and the ordering service include a distribution service for distributing a program or data to the user terminal 40 via a network 50 and a storage service for storing data received from the user terminal 40. The distribution service is, for example, a service that distributes data for update.

The user terminal 40 is a computer device capable of network connection. For example, the user terminal 40 includes a stationary or book type personal computer 41, a portable tablet terminal device 42, and the like. In addition, a mobile terminal device such as a mobile phone (including a smartphone) is included in the user terminal 40. The user terminal 40 can cause the user to enjoy various services provided by the estimation server 10 by implementing various computer programs. Further, the user terminal 40 can be connected to the estimation server 10 via a predetermined network 50. Hereinafter, an example in which the user terminal 40 is the personal computer 41 will be mainly described.

The network 50 is configured such that each user terminal 40 can be connected to the estimation server 10. Further, the network 50 is configured to realize network communication by using a TCP/IP protocol. Specifically, a local area network (LAN) 52 connects the estimation server 10 and the Internet 51. Then, the Internet 51 as a wide area network (WAN) is connected to the LAN 52 via a router 53. Further, the network 50 may be any of a dedicated line, a telephone line, an in-enterprise network, a mobile communication network, other communication lines, and combinations thereof, and may be wired or wireless. The user terminal 40 is also configured to be connected to the Internet 51. Alternatively, the server unit 11 of the estimation server 10 may be connected to the user terminal 40 via the Internet 51 instead of or in addition to the LAN 52.

Furthermore, the estimation server 10 functions as a web server that displays various web pages on the display part of the user terminal 40 according to access from the user terminal 40. Further, the estimation server 10 executes processing such as arranging an ordered article, a transport instruction, and billing of a purchase price in response to an order placed by the user. Furthermore, the estimation server 10 provides an assembly design support service to the user terminal 40 or the user of the user terminal 40. For example, the estimation server 10 provides the design support service to the user via a design support program distributed to the user terminal 40.

### [Design Support Service]

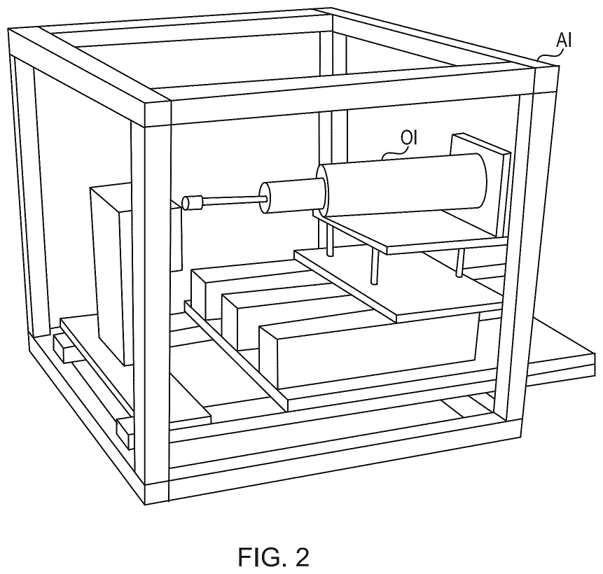

The assembly design support service will be described with reference to FIG. 2. Incidentally, the assembly itself may be a finished product having one integrated function, or may be one article incorporated into the finished product. Furthermore, the assembly includes a unit, a jig, a device, and equipment in which a plurality of components is combined. FIG. 2 illustrates an assembly image AI illustrating a frame body having a plurality of frames as an example of the assembly. Further, the frame body accommodates a core device which is an example of an object, and FIG. 2 illustrates an object image OI indicating the core device.

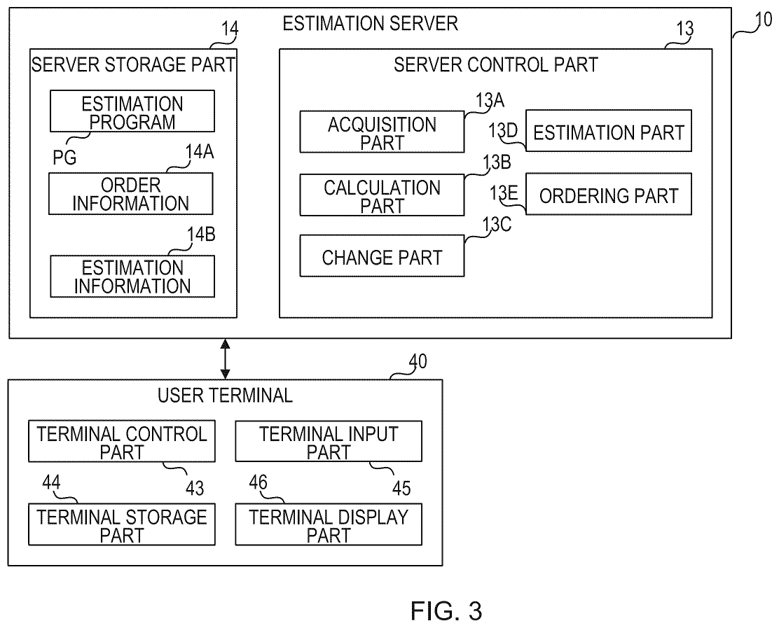

The user terminal 40 that designs the frame body as illustrated in FIG. 2 includes a terminal control part 43 and a terminal storage part 44 illustrated in FIG. 3. Then, the terminal control part 43 reads a design support program (not illustrated) from the terminal storage part 44 to support assembly design. For example, the terminal storage part 44 stores in advance template data of an assembly, object data of an object to be accommodated in the assembly, and component data of components constituting the assembly. Alternatively, the template data, the object data, and the component data may be obtained from an external device (for example, the estimation server 10).

In FIG. 2, the assembly is the frame body assembled from twelve aluminum frames. Then, the aluminum frames are fixed to each other by a bracket (not illustrated). Specifically, each aluminum frame is arranged at a position of each side of the frame body. Further, the template data of the assembly includes a template of computer aided design (CAD) data related to a shape used for the assembly. As an example, the template data includes coordinate values indicating a reference position (for example, the barycentric position of the assembly) of the assembly on the three-dimensional coordinate system. Further, the template data includes coordinate values indicating positions of components of the assembly in the three-dimensional coordinate system. Incidentally, the template is a template for simply designating an assembly constituted by assembling a plurality of components.

Further, the object data is CAD data of an object to be housed in the assembly that is a design object. Then, the object data includes coordinate values indicating a reference position (for example, the barycentric position of the object) of the object on the three-dimensional coordinate system. Further, the object data may include coordinate values indicating the position of each component constituting the object on the three-dimensional coordinate system. Alternatively, the object data may be CAD data of a simplified profile of the core device to be contained in the assembly. Furthermore, the object data may be CAD data of an object to be arranged outside the assembly or an object to be arranged around the assembly.

The component data is CAD data of each component selectable from a plurality of component candidate groups that can be used to constitute an assembly. As an example, the component candidate group includes an aluminum frame, a bracket, a bolt, a cap, a door, and the like. Furthermore, the component candidate group may include a unit constituted by a plurality of members. More specifically, the component candidate group includes a post-insertion type bracket, a pre-insertion type blind bracket, a post-insertion type blind bracket, a right-angle connection bracket, a normal type corner bracket, a corner blind bracket, a reinforcing frame bracket, a panel support bracket, a door corner bracket, a frame cap with a bolt, and a frame cap without a bolt.

Furthermore, the component candidate group may include an anchor type anchor stand, an insertion type anchor stand, an adjuster pad, a safety fence unit, a caster/adjuster pad unit, a cable clamp, a cable hook, a corner angle fixing type caster, a screwed type caster, a four-hole fixing type caster, a foot base, a flanged nut, a pre-insertion type nut, a post-insertion type nut, a nut accessory, a tapping joint, a screw joint, a single joint, a center joint, a pre-insertion type double joint, a post-insertion type double joint, a parallel joint, a resinous trench cover, a non-resinous trench cover, a magnet catch, a bracket fastening type panel, a frame fastening type panel, a clamp fastening type panel, a panel clamp, a plate, a sheet metal plate, a single-opening door, a double door, a folding door, a single-handed panel door, a two-handed panel door, a frame for a door, a T-shaped bolt, a door spacer trench cover, an attachment plate, a male screw type handle, a female screw type handle, a hinge, a tableting lock, a nut, and the like.

When the input operation by the user is an operation of reading template data, the terminal control part 43 recognizes the shape of the template to be read, the type of component, and the size, position, and posture of the assembly. Then, the terminal control part 43 refers to the template data and draws each component included in the assembly on the three-dimensional coordinate system. Thus, the terminal control part 43 displays the assembly image AI on a terminal display part 46 (FIG. 3) of the user terminal 40. Furthermore, the terminal control part 43 receives designation of the position and posture of the assembly by the user. Further, in a case where the input operation by the user is an operation of reading object data, the terminal control part 43 recognizes the size, position, and posture of the object. Then, the terminal control part 43 refers to the object data and draws each part included in the object on the three-dimensional coordinate system. Thus, the terminal control part 43 displays the object image OI on the terminal display part 46. Furthermore, the terminal control part 43 receives designation of the position and posture of the object by the user.

Further, in a case where the input operation by the user is an operation of arranging a component, the terminal control part 43 recognizes a range of each coordinate value indicating a position of an arrangement candidate of the component. As an example, a position of the arrangement candidate is a position surrounding an object and a position in contact with the object. Then, the terminal control part 43 causes the terminal display part 46 to display the image of the component arranged at the position of the arrangement candidate. Furthermore, the terminal control part 43 receives designation of the size, position, and posture of the component by the user. In this way, the user can design an assembly constituted by components surrounding the periphery of the object as illustrated in FIG. 2. Incidentally, the terminal control part 43 can also determine the presence or absence of interference between an object and a component and interference between components. When the interference occurs, the terminal control part 43 may present a warning to the user.

### [Control System]

Next, a schematic configuration of a control system of the estimation system 100 will be described with reference to FIG. 3. The estimation server 10, which is an example of an estimation management unit, includes a server control part 13 as a control unit of the estimation server 10 and a server storage part 14 as a non-transitory computer-readable storage medium. Then, the server control part 13 is configured as a computer in which a processor that executes various arithmetic processes and operation control according to a predetermined program, an internal memory necessary for the operation of the processor, and other peripheral devices are combined. The processor is, for example, a central processing unit (CPU) or a micro-processing unit (MPU), and controls the entire server device on the basis of an estimation program PG stored in the server storage part 14 and also controls various processes in an integrated manner. Incidentally, the server control part 13 can also perform control according to a program stored in a portable recording medium such as a CD, a DVD, a CF card, and a USB memory, or an external storage medium such as a cloud server on the Internet.

The server storage part 14 includes random access memory (RAM) that is a system work memory for the processor to operate, and a storage device such as a read only memory (ROM), a hard disc drive (HDD), and a solid state drive (SSD) that store a program and system software. However, the server storage part 14 is not limited to the example provided as a part of the estimation server 10, and may be provided as a database server that cooperates with the estimation server 10. In the following description, an example in which the CPU executes processing operations such as various calculations, controls, and determinations according to the program stored in the ROM or the HDD will be described.

The server control part 13 includes an acquisition part 13A, a calculation part 13B, a change part 13C, an estimation part 13D, and an ordering part 13E as logical devices implemented by a combination of computer hardware and software. Then, the estimation program PG stored in the server storage part 14 causes the server control part 13 that is a computer to function as the acquisition part 13A that is an example of an acquisition unit, the calculation part 13B that is an example of a calculation unit, the change part 13C that is an example of a change unit, the estimation part 13D that is an example of an estimation unit, and the ordering part 13E that is an example of an ordering unit. Incidentally, the server control part 13 has, in addition to the logical devices described above, for example, a logical device (not illustrated) that controls switching display of a web page according to an operation of the user terminal 40, and the like.

### [Acquisition Unit]

The acquisition part 13A acquires component specifying information for specifying components constituting an assembly from a component candidate group. Further, the acquisition part 13A acquires specification information for specifying a specification of an assembly constituted by the components specified by the component specifying information. As an example, the component specifying information is a component code commonly set for a plurality of components, or a name, a model number, or component identification information set for each component. Further, the specification information is information related to the specification of the assembly, and includes, as an example, assembly information such as a size (for example, a length, a width, a height, a depth, an inner dimension, an outer dimension, a thickness, a length of one side, and the like) of the entire assembly or a part of the assembly, a weight (for example, weight, mass, and the like), and the component RECORDs number indicating the number of components included in the assembly. Furthermore, the specification information includes assembly information such as the presence or absence of the match mark, an arrangement method of a nut to be used, the type of the nut to be used, and the type of the component (for example, door). Incidentally, the match mark is a mark for aligning components for proper assembly or a mark indicating a position of an object with respect to the assembly.

For example, the acquisition part 13A acquires component specifying information (for example, the model number of the component) input or designated by the user. Further, the acquisition part 13A acquires, as specification information, assembly information (for example, a size of an assembly, and the like) based on the specification of the assembly (for example, a length of a frame and the like) input or designated by a user. As an example, the acquisition part 13A acquires, as the assembly information, a dimension, a weight, or the like of an assembly recognized from CAD data of the assembly. Further, the acquisition part 13A acquires the assembly information (for example, presence or absence of a match mark, and the like) of an assembly input or designated by the user. As an example, the specification information and the component specifying information are associated with order identification information (for example, order number) for identifying an order input by the user. Then, the specification information and the component specifying information are included in the order information 14A and stored in the server storage part 14. Incidentally, the order information 14A further includes information indicating an estimation result associated with the order identification information.

### [Calculation Unit]

The calculation part 13B calculates an assembly cost for assembling the assembly according to the specification specified by the specification information from each component specified by the component specifying information using a predetermined calculation rule. The calculation rule includes a first rule set for each component of the component candidate group and a second rule set for at least one component of the component candidate group with respect to the specification information. Furthermore, the second rule is set for each specification category classified into a plurality of specification categories according to the specification information. As an example, the first rule and the second rule of the calculation rule are associated with the component specifying information (for example, a component code) for specifying each component of the component candidate group. Then, the server storage part 14 includes a calculation rule in a table format in the estimation information 14B and stores the calculation rule.

Each component constituting the assembly is specified by the component specifying information. Then, the user can select each component from a preset component candidate group. As an example, the specification category includes two categories of “reaching a length corresponding to a predetermined numerical value” and “not reaching the length corresponding to the predetermined numerical value” according to the assembly information of the size of the assembly. Further, the specification category includes two categories of “there is a match mark” and “there is no match mark” according to the assembly information of the presence or absence of the match mark. Incidentally, classification of the specification categories is for convenience of description, and may not be classified by a table. For example, the specification category may be defined by an option of condition determination performed by the calculation part 13B.

As an example, the first rule is set for each component of the component candidate group. The number of first rules set for one component may be one or plural. For example, a plurality of first rules may be set for the aluminum frame. Further, as an example, the second rule is set for each of two specification categories of “there is a match mark” and “there is no match mark” with respect to an aluminum frame that is one component. The number of second rules set for one component may be one or plural. For example, a plurality of second rules may be set for a specification category of “there is a match mark”.

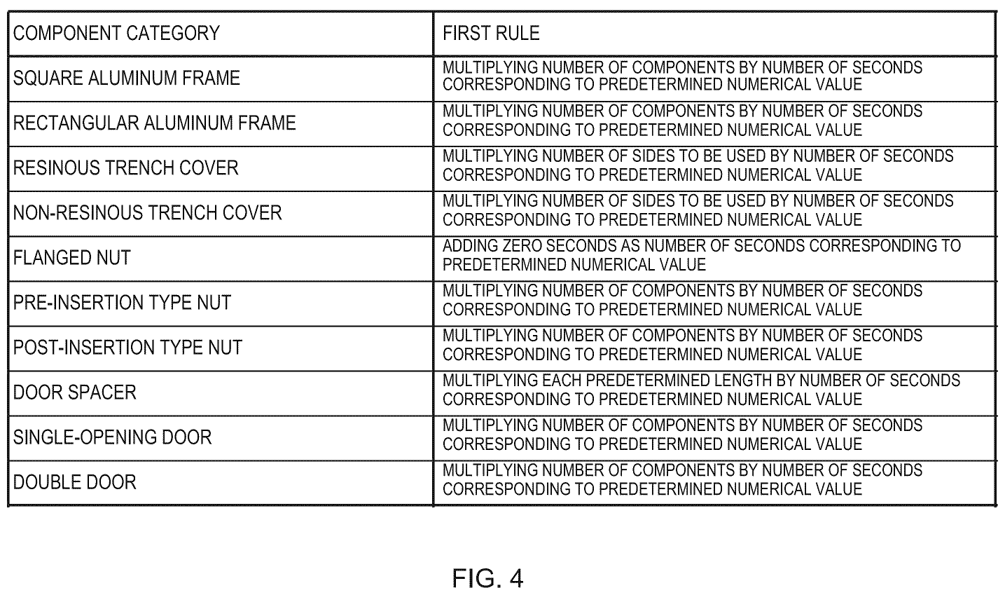

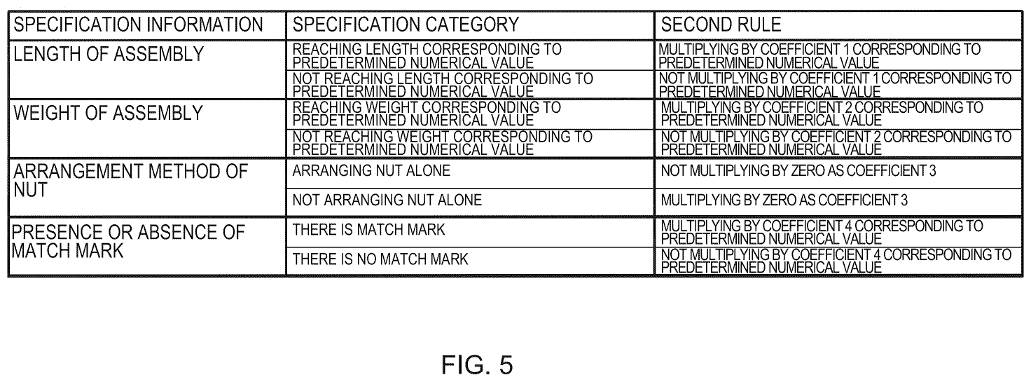

Next, the first rule and the second rule will be described in more detail with reference to FIGS. 4 and 5. As illustrated in FIG. 4, the first rule is set for each component category classified into a plurality of component categories according to the component specifying information. There is a plurality of component categories, and a component specified by the component specifying information belongs to each component category. Then, the first rule is set for each component category. For example, the first rule of “multiplying the number of components by the number of seconds corresponding to a predetermined numerical value” is set in a component category of square aluminum frame. Incidentally, a plurality of types of components specified by the component specifying information may belong to the same component category. For example, a square aluminum frame and a rectangular aluminum frame respectively have different component specifying information (for example, the model number of the component), but may belong to the same component category (for example, an aluminum frame). Further, a plurality of types of components (for example, a square aluminum frame and a rectangular aluminum frame) may be specified by common component specifying information (for example, a component code).

Further, as illustrated in FIG. 5, the second rule is set for each specification category classified into a plurality of specification categories according to the specification information. For example, the assembly is the frame body, and the components of the assembly is frames (for example, square aluminum frames) constituting the frame body. In this case, the specification information acquired by the acquisition part 13A is at least one of the size or the weight of the assembly. Then, the specification category corresponding to the size of the assembly includes the category of reaching the length corresponding to the predetermined numerical value and the category of not reaching the length corresponding to the predetermined numerical value. Further, the specification category corresponding to the weight of the assembly includes a category of reaching a weight corresponding to a predetermined numerical value and a category of not reaching a weight corresponding to a predetermined numerical value.

Then, the second rule is set for each specification category, and the second rule is set for at least one component. In the example of FIG. 5, a specification category of “reaching the length corresponding to the predetermined numerical value” and a specification category of “not reaching the length corresponding to the predetermined numerical value” are provided corresponding to the specification information of the length of the assembly. Then, the second rule of “multiplying by a coefficient corresponding to a predetermined numerical value” is set to the specification category of “reaching the length corresponding to the predetermined numerical value”. As described above, the second rule is set for the square aluminum frame and the rectangular aluminum frame. Incidentally, a plurality of types of components specified by the component specifying information may belong to the same specification category. For example, the square aluminum frame and the rectangular aluminum frame constituting assemblies of the same size and weight belong to the same specification category.

Specifically, the calculation part 13B calculates the assembly cost by multiplying an assembly time of the assembly by the cost. Then, the first rule is set to calculate the assembly time of each component of the component candidate group. Furthermore, the second rule is set to correct the assembly time of at least one component calculated using the first rule. For example, the calculation part 13B determines whether or not the specification specified on the basis of the specification information satisfies a predetermined condition for a certain component. Then, when the condition is satisfied, the component belongs to the specification category corresponding to the condition. Therefore, the calculation part 13B corrects the assembly time using the second rule set for the specification category.

As an example, when one square aluminum frame is used, the calculation part 13B calculates the assembly time by using the first rule of multiplying the number of square aluminum frames by the number of seconds (for example, 120 seconds) corresponding to the predetermined numerical value. Furthermore, in a case where a condition that the length corresponding to the predetermined numerical value is reached is satisfied, the calculation part 13B performs correction using the second rule that the calculated assembly time is multiplied by a coefficient (for example, 1.5) according to the predetermined numerical value. Thus, the calculation part 13B calculates the assembly time of one square aluminum frame. Furthermore, the calculation part 13B calculates the assembly cost by multiplying the calculated assembly time by a cost corresponding to a predetermined numerical value (for example, 2 yen per second). Incidentally, an administrator of the estimation server 10 can change the setting of the predetermined numerical value.

In this manner, the calculation part 13B calculates the assembly time for each component. Here, circumstances to be considered in the calculation of the assembly time are different for each component. For example, there are components whose weight should be considered and components whose size should be considered in calculating the assembly time. Further, it is necessary to correct and lengthen the assembly time for components that require time for attachment. Therefore, by calculating or correcting the assembly time in consideration of circumstances peculiar to each component, the assembly time and the assembly cost can be calculated with higher accuracy. Therefore, the first rule is set for each component category.

Then, the calculation part 13B calculates the assembly time for each component category, and calculates the assembly cost of the assembly by summing the assembly costs of the respective component categories. Further, in the case of estimating the assembly cost of a plurality of assemblies, the calculation part 13B calculates the assembly cost of one assembly, and then multiplies the assembly cost by the number of assemblies to calculate the assembly cost of the plurality of assemblies. Incidentally, when an additional component (for example, a spare component) not used for assembly is included in the order, the calculation part 13B does not calculate the assembly cost for the additional component. That is, the calculation part 13B calculates the assembly cost only for the components constituting the assembly.

As a specific example, when the first rule illustrated in FIG. 4 is used, the calculation part 13B calculates the assembly time as follows. That is, when the first rule of “multiplying the number of components by the number of seconds corresponding to the predetermined numerical value” is used, the acquisition part 13A acquires the number of components identified by the component specifying information to be used for assembly. Then, the calculation part 13B calculates the assembly time by multiplying the number of components by the number of seconds corresponding to a predetermined numerical value as a preset variable.

Further, in the case of using the first rule of “multiplying the number of sides to be used by the number of seconds corresponding to a predetermined numerical value”, the acquisition part 13A acquires the number of sides of the assembly in which the component specified by the component specifying information is used based on the CAD data of the assembly. Then, the calculation part 13B calculates the assembly time by multiplying the number of sides by the number of seconds corresponding to the predetermined numerical value. Further, in the case of using the first rule of “adding zero seconds as the number of seconds corresponding to a predetermined numerical value”, the calculation part 13B adds zero seconds. In this case, the assembly time is not increased or decreased. For example, when a nut and a bolt are used to attach the frame, if the time required for attaching the frame is added, it is not necessary to add the time required for attaching the nut in an overlapping manner. Therefore, zero seconds are added so as not to add the assembly time of the nut. Incidentally, the first rule of adding zero seconds may be a rule of not calculating the assembly time.

Further, in the case of using the first rule of “multiplying each predetermined length by the number of seconds corresponding to a predetermined numerical value”, the acquisition part 13A acquires the number of components specified by the component specifying information to be used and the length of one component. Furthermore, the acquisition part 13A calculates the total length of the components in the assembly by multiplying the number of components by the length of the component. Then, the calculation part 13B calculates the assembly time by multiplying a value, which is obtained by dividing the total length of the components by a predetermined length, by the number of seconds corresponding to the predetermined numerical value. Incidentally, the first rule is an example, and another first rule may be included in the calculation rule. Further, the first rule may be a rule of “multiplying the number of seconds corresponding to a predetermined numerical value for each predetermined size”. In this case, the acquisition part 13A acquires the number of components specified by the component specifying information to be used and the size (for example, area) of the component. Then, the calculation part 13B calculates the assembly time by multiplying a value, which is obtained by dividing the entire size of the components by a predetermined size, by the number of seconds corresponding to the predetermined numerical value.

As a specific example, when the second rule illustrated in FIG. 5 is used, the calculation part 13B corrects the assembly time as follows. For example, the specification information of the length of the assembly and the weight of the assembly corresponds to the square aluminum frame and the rectangular aluminum frame. Therefore, when the square aluminum frame and the rectangular aluminum frame are included in the components, the acquisition part 13A acquires the length of the assembly and the weight of the assembly as the specification information based on the CAD data of the assembly. Then, the calculation part 13B determines whether the condition that the length of the assembly reaches the length corresponding to the predetermined numerical value is satisfied or a condition that the length of the assembly does not reach the length corresponding to the predetermined numerical value is satisfied. Then, in a case where the condition that the length corresponding to the predetermined numerical value is reached is satisfied, the calculation part 13B multiplies the calculated assembly time by a coefficient 1 using the second rule.

Furthermore, the calculation part 13B determines whether a condition that the length of the assembly reaches the weight corresponding to the predetermined numerical value is satisfied or a condition that the weight corresponding to the predetermined numerical value is not reached is satisfied. Then, in a case where the condition that the weight corresponding to the predetermined numerical value is reached is satisfied, the calculation part 13B multiplies the calculated assembly time by a coefficient 2 using the second rule. Taking the square aluminum frame as an example, the calculation part 13B multiplies the number of components by the number of seconds corresponding to the predetermined numerical value using the first rule. Then, the calculation part 13B multiplies the calculated number of seconds by the coefficient 1 and further multiplies the result by the coefficient 2. Thus, the calculation part 13B corrects the assembly time of the square aluminum frame.

Further, the specification information of the nut arrangement method corresponds to the pre-insertion type nut. Therefore, when the pre-insertion type nut is included in the components, the acquisition part 13A acquires the nut arrangement method as the specification information. Then, the calculation part 13B determines whether the nut arrangement method satisfies the condition that the nut is arranged alone or the condition that the nut is not arranged alone. Then, in a case where the condition that the nut is arranged alone is satisfied, the calculation part 13B multiplies the calculated assembly time by 0 as a coefficient 3 using the second rule. In this case, the assembly time of the pre-insertion type nut is zero. Incidentally, the second rule of multiplying by zero may be a rule of not calculating the assembly time.

The specification information of the presence or absence of the match mark corresponds to the bolt. Therefore, when the bolt is included in the component, the acquisition part 13A acquires the presence or absence of the match mark as the specification information. Then, the calculation part 13B determines whether the condition that there is a match mark is satisfied or the condition that there is no match mark is satisfied. Then, in a case where the condition that there is the match mark is satisfied, the calculation part 13B multiplies the calculated assembly time by a coefficient 4 using the second rule. Incidentally, the coefficients 1 to 4 may be the same numerical value or different numerical values.

In this manner, the calculation part 13B calculates the assembly cost by using the first rule set for each component and the second rule set for at least one component and set for each specification category. Then, a complicated calculation rule can be configured by combining the first rule and the second rule. Therefore, it is possible to calculate assembly cost with higher accuracy by setting a calculation rule with a high degree of freedom. That is, the calculation part 13B calculates the assembly time being a basis by using the first rule for each component, and further corrects the assembly time using the second rule set for a specific component. Then, the calculation part 13B calculates the assembly cost based on the calculated assembly time. In this manner, the first rule and the second rule set for the components can be combined. Therefore, the degree of freedom in setting the calculation rule can be increased as compared with the case where the assembly time is calculated only from the specifications of the entire assembly. Thus, the calculation rule can be set so that calculation accuracy becomes higher.

Furthermore, the calculation part 13B calculates the transportation cost of the assembly. Specifically, the calculation part 13B refers to the specification information corresponding to the second rule set for a basic component among the components constituting the assembly. Then, the calculation part 13B calculates the transportation cost of the assembly based on the referred specification information. Thus, the calculation part 13B refers to the common specification information for calculation of the transportation cost and calculation of the assembly cost. Therefore, the assembly cost and the transportation cost can be estimated in one estimation procedure. Incidentally, the basic component is a component that occupies most of the assembly. Further, a plurality of types of components may be the basic component.

As an example, a case where the square aluminum frame is the basic component of the frame body will be described. In this case, the acquisition part 13A acquires the length of the frame body, specifically, the dimensions of the length, the width, and the height as the specification information corresponding to the second rule set for the basic component. Furthermore, the acquisition part 13A calculates and acquires the weight of the frame body. Then, the calculation part 13B selects a transportation means (for example, mixed service, charter service, shipping service, air service, 10 ton truck, 4 ton truck, or the like) corresponding to at least one of the acquired length or weight with reference to the specification information such as the length and weight of the frame body. As an example, the transportation means corresponding to the length and the weight are included in the estimation information 14B in the form of a table. Incidentally, when only one of the length and the weight is used, acquisition of the another of the length and the weight can be omitted. Further, in the case of estimating the transportation cost of a plurality of assemblies, the calculation part 13B may calculate the size, weight, or the like of the entire assembly on the basis of the specification of one assembly and select the corresponding transportation means.

Furthermore, the calculation part 13B calculates a transportation distance on the basis of a transportation destination location input by the user and the location of a base that is the transportation source of the frame body included in the estimation information 14B. At this time, when there is a plurality of bases to which the frame body can be dispatched, the calculation part 13B calculates the transportation distance from the base closest to the transportation destination to the transportation destination. Then, the calculation part 13B calculates the transportation cost according to the transportation distance with reference to a table of transportation costs corresponding to the selected transportation means. Incidentally, the table of transportation costs is included in the estimation information 14B. In this manner, the calculation part 13B can calculate the transportation cost. Incidentally, when the calculation of the transportation cost is unnecessary, for example, when the transportation cost is a fixed amount for all the assemblies, the calculation processing of the transportation cost can be omitted.

The calculation part 13B calculates a delivery date of the assembly. For example, the calculation part 13B converts the calculated assembly time into the number of days, and adds the number of days to the longest or latest delivery date among delivery dates of the components. Specifically, when the number of days obtained by converting the assembly time is one day and the delivery date of the longest component is two days, the delivery date of the assembly is three days. In this manner, the calculation part 13B calculates the delivery date of the assembly. Furthermore, the calculation part 13B may add a predetermined time or number of days to the delivery date in preparation for a case where a delay occurs in assembly or receipt of components.

Incidentally, the delivery date is actual work days required for shipping the product as a component or an assembly, an arrival date when the product reaches the user, a production completion date of the product, a processing completion date of the product, an arrival date when the product reaches a physical distribution base, and the like. The delivery date is a specific date or time, but the delivery date is only required to be information that can identify the timing of receipt of the product by the user, and may be a length of time required for shipment, arrival, or completion, or a length of time required for transportation. Further, when the delivery dates of a plurality of assemblies are estimated, the calculation part 13B may calculate and add the assembly time of the entire assemblies based on the assembly time of one assembly.

### [Change Unit]

At least one of the first rule or the second rule includes a condition rule part that designates a calculation condition and a numerical value rule part that designates a numerical value to be applied to calculation. Then, the calculation condition designated by the condition rule part is fixed. On the other hand, the numerical value in the numerical value rule part can be changed, and the change part 13C receives a change in setting of the numerical value in the numerical value rule part. As an example, the setting of the numerical value is changed by the administrator of the estimation server 10. Alternatively, the user or the supplier may change the setting of the numerical value.

Specifically, the first rule of “multiplying the number of components by the number of seconds corresponding to the predetermined numerical value” includes a condition rule part that designates a calculation condition of “multiplying the number of components by the number of seconds” and a numerical value rule part of “the predetermined numerical value”. Further, the second rule of “multiplying by the coefficient corresponding to the predetermined numerical value” includes the condition rule part that designates a calculation condition of “multiplying by the coefficient” and the numerical value rule part of “the predetermined numerical value”. Then, the administrator of the estimation server 10 can change the setting of the predetermined numerical value to arbitrary value, and the change part 13C receives the setting change. Incidentally, the change part 13C may further receive the setting change of the predetermined numerical value included in the specification category. For example, the change part 13C may receive the setting change of the predetermined numerical value of the specification category of “reaching the length corresponding to the predetermined numerical value”. Incidentally, the coefficient corresponding to the predetermined numerical value of the second rule is a numerical value larger than 1 or a numerical value smaller than 1, and as an example, the predetermined coefficient is 1.5 or 0.5.

### [Estimation Unit]

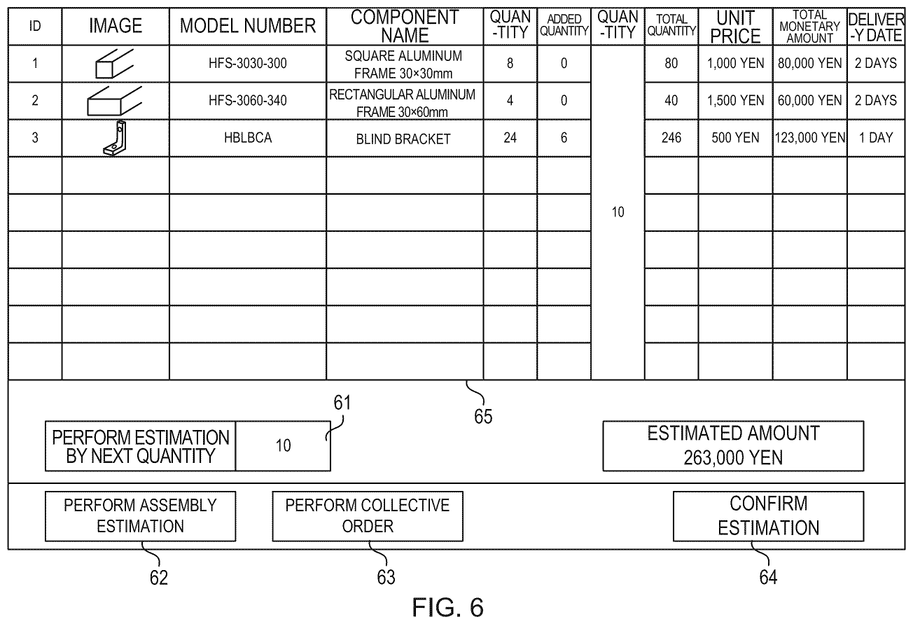

The estimation part 13D presents a unit price of each component of the assembly, the total monetary amount of each component, an estimated monetary amount of the assembly, the assembly cost, the transportation cost, and the delivery date to the user as the estimation result. As an example, the estimation part 13D presents the estimation result to the user by displaying the unit price of each component of the assembly and the total monetary amount of each component on the estimation screen illustrated in FIG. 6. Furthermore, the estimation part 13D presents the delivery date (for example, the number of days of actual working days required until shipment, and the like) as the estimation result to the user. Alternatively, the estimation part 13D may present the estimation result to the user by notifying the user of the estimation result by another means such as e-mail.

For example, in the example illustrated in FIG. 6, the user wants ten assemblies. Then, the quantity of blind brackets desired by the user is 246, and 240 of them are used to assemble ten assemblies. Further, the user also wants six blind brackets as additional components, such as spare components. Then, on the estimation screen, a total quantity of 246 blind brackets, a unit price of 500 yen per one blind bracket, a total monetary amount of 123000 yen, and actual work days required for shipping as a delivery date of 2 days are displayed in a component field 65. Further, a total monetary amount of 263000 yen for all the components is displayed as the estimated monetary amount. Incidentally, the user can input the quantity of additional components on the estimation screen, and the acquisition part 13A acquires the quantity. However, the user may be able to input the quantity of additional components on a components list screen (not illustrated) before transitioning to the estimation screen.

Further, the estimation screen is provided with a quantity input field 61, an assembly estimate button 62, a collective order button 63, and an estimation confirmation button 64. The user can input a desired number in the quantity input field 61, and the acquisition part 13A acquires the number. Further, the user can select the estimation confirmation button 64 to confirm the estimation. The user can then order the components in a pre-assembled state on an order screen (not illustrated) displayed by selecting the collective order button 63. Incidentally, the collective order button 63 may be displayed after the estimation is confirmed.

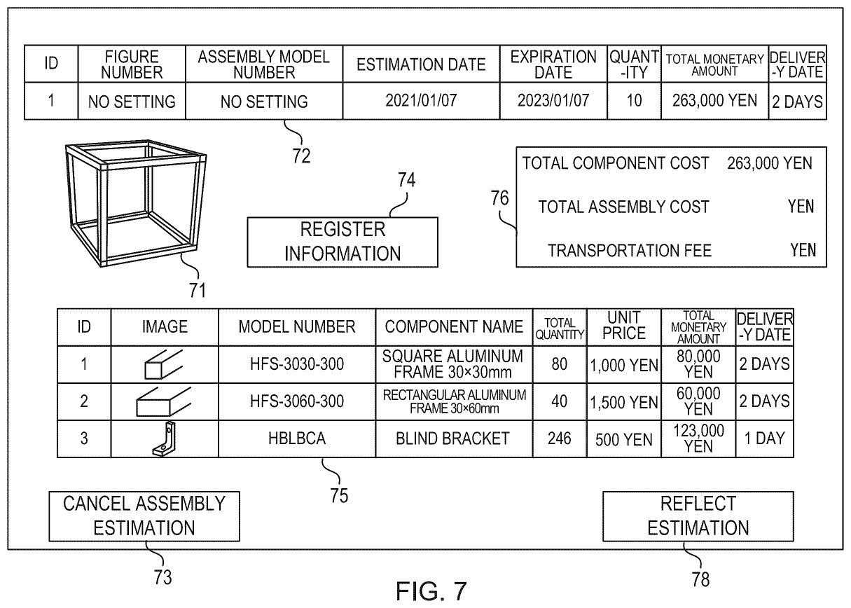

Furthermore, if the user wishes to estimate the assembly cost, the user selects the assembly estimate button 62. When the user selects the assembly estimate button 62, the estimation part 13D displays an assembly estimation screen illustrated in FIG. 7. The assembly estimation screen, in which an image 71 of an assembly is displayed, is provided with an assembly information field 72 in which information of the assembly such as an assembly model number is displayed. The expiration date of the estimation (Jan. 7, 2023 in the example of FIG. 7) is displayed in the assembly information field 72. The user can purchase the assembly according to the condition indicated in the estimation result by placing an order within the expiration date.

Further, an estimation cancel button 73 and an information registration button 74 are provided on the assembly estimation screen. Furthermore, the assembly estimation screen is provided with a component field 75 for displaying the unit price and the like of each component. Incidentally, the server storage part 14 stores the components constituting the assembly and the number of the assemblies in association with the assembly model number. Therefore, when ordering the same number of assemblies constituted by the same components, the user can order using the assembly model number used last time.

Further, the user can cancel the assembly estimation by selecting the estimation cancel button 73. In this case, the estimation part 13D displays the estimation screen of FIG. 6 again. Furthermore, the user can select the information registration button 74 to input the specification information necessary for the assembly estimation. When the user selects the information registration button 74, the estimation part 13D displays an input screen (not illustrated). The user inputs the specification information and the transportation destination on the input screen. For example, the user inputs the presence or absence of the match marks as the specification information and inputs the address of the transportation destination.

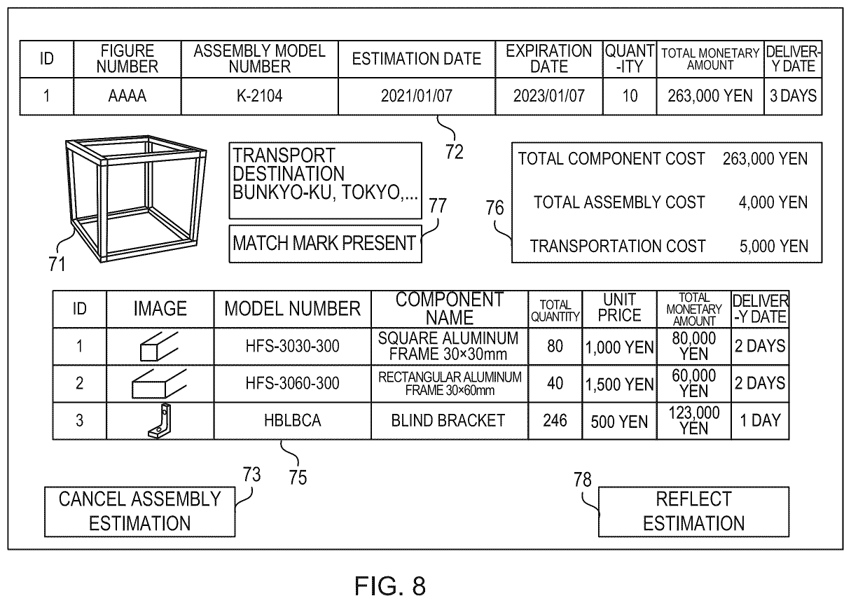

When the user inputs necessary information, the calculation part 13B performs calculation processing, and the estimation part 13D refers to the calculation result by the calculation part 13B. This calculation result is included in the order information 14A. Then, the estimation part 13D displays the assembly cost on the assembly estimation screen illustrated in FIG. 8. That is, the estimation part 13D displays the assembly cost and the transportation cost in an estimation result field 76 on the assembly estimation screen. Furthermore, the estimation part 13D displays the delivery date of the assembly in consideration of the assembly time in the assembly information field 72. In the example of FIG. 8, one day of assembly time is added to two days, which is the delivery date of the component, so that the delivery date of the assembly is three days. Furthermore, in the assembly information field 72 after assembly estimation, an assembly model number and a drawing number for specifying the CAD data of the assembly are illustrated.

Further, the assembly estimation screen illustrated in FIG. 8 is provided with an input information field 77 indicating information such as an address input by the user. Then, the user checks the estimation result field 76 and the input information field 77, and selects an estimation reflection button 78. Thus, the result of the assembly estimation is reflected on the estimation screen. Then, the user can select the estimation confirmation button 64 on the estimation screen to confirm the estimation. Thereafter, the estimation part 13D displays the order screen (not illustrated). The user can order the assembled assembly from the order screen. In this manner, the estimation part 13D presents the assembly cost and the like to the user. Therefore, the user does not need to request an estimation of the assembly cost separately and receive an answer. Thus, the work and time for confirmation can be reduced.

Incidentally, when the assembly estimation cannot be performed, the estimation part 13D may display a warning indicating that the assembly estimation cannot be performed. For example, the assembly estimation cannot be performed when components interfere and the assembly cannot be assembled, when the component is not placed in the correct position, or when the size of the assembly exceeds the transportable size. Alternatively, when the assembly estimation cannot be performed, the estimation part 13D may prevent the user from selecting the assembly estimate button 62.

### [Ordering Unit]

The ordering part 13E performs an assembly ordering process and a component ordering process corresponding to the collective order. For example, when the user orders the assembly, the ordering part 13E transmits the assembly model number, the number of products purchased, and the model numbers of the components corresponding to the user's order to the supplier. Further, when the user places a collective order, the ordering part 13E transmits the model number and the purchase quantity of the component corresponding to the user's order to the supplier. Incidentally, the specification of the assembly and the specification of the components constituting the assembly are included in the order information 14A. Then, the ordering part 13E also transmits these pieces of information to the supplier as necessary. Alternatively, components delivered from the supplier may be assembled by the vendor and transported to the user. In this case, transmission of the specification of the assembly and the like to the supplier can be omitted.

### [User Terminal]

As illustrated in FIG. 3, the user terminal 40 includes the terminal control part 43 that controls the user terminal 40, and the terminal storage part 44 that stores a control program and a design support program. The terminal control part 43 is a computer in which a processor that executes various arithmetic processes and operation control according to a predetermined program and other peripheral devices are combined. Further, the user terminal 40 includes the terminal display part 46 and a terminal input part 45. Incidentally, the terminal input part 45 is a keyboard, a numeric keypad, a touch panel, or the like, and the user inputs specification information or the like using the terminal input part 45. Further, the terminal display part 46 displays a web page such as an estimation screen, and the user confirms an estimation according to the displayed web page, and the like.

As an example, the processor of the terminal control part 43 is, for example, a CPU or an MPU, and controls the entire terminal based on the control program stored in the terminal storage part 44 and also controls various processes in an integrated manner. Further, the terminal storage part 44 further includes a RAM that is a system work memory for the processor to operate, and a storage device such as a ROM, an HDD, and an SSD that store a program and system software. Incidentally, the terminal control part 43 can also perform control according to a program stored in a portable recording medium such as a CD, a DVD, a CF card, and a USB memory, or an external storage medium such as a cloud server on the Internet. Further, the terminal storage part 44 is a storage device including a non-volatile storage medium (non-transitory computer-readable storage medium).

### [Calculation Process]

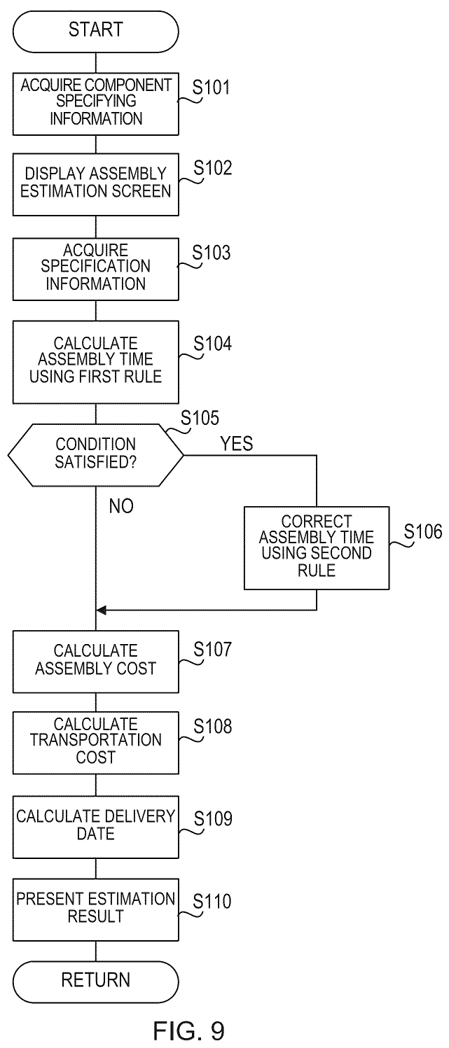

An assembly cost calculation process in the estimation system 100 will be described with reference to FIG. 9. When the user selects the component of the assembly, the acquisition part 13A acquires the component specifying information input or designated by the user (S101). For example, the user can check components constituting a desired assembly and input the number of additional components on the components list screen. Further, the components constituting the assembly can be designated by the user when designing the assembly. Then, the acquisition part 13A acquires the component specifying information input or designated by the user. Furthermore, the terminal control part 43 may automatically select the component included in the read template of the assembly.

If the user wishes to estimate the assembly cost, the user selects the assembly estimate button 62. Then, the estimation part 13D causes the terminal display part 46 to display the assembly estimation screen illustrated in FIG. 7 (S102). The user selects the information registration button 74 to input specification information (for example, the presence or absence of the match marks) necessary for assembly estimation. Then, the acquisition part 13A acquires the specification information input by the user (S103). Furthermore, the acquisition part 13A further acquires specification information (for example, the size and weight of the assembly) based on the specification of the assembly input or designated by a user.

Then, the calculation part 13B calculates the assembly time of the component specified by the component specifying information using the first rule set for the components (S104). Furthermore, the calculation part 13B determines whether or not the specification specified on the basis of the specification information satisfies the predetermined condition for the component (S105). Then, when the condition is satisfied (YES in S105), the calculation part 13B corrects the assembly time using the second rule set to the specification category corresponding to the condition (S106). Then, the calculation part 13B calculates the assembly cost by multiplying the corrected assembly time by a predetermined cost (S107). On the other hand, when the condition is not satisfied (NO in S105), the calculation part 13B calculates the assembly cost by multiplying the calculated assembly time by the predetermined cost (S107).

Furthermore, the calculation part 13B selects transportation means of the assembly with reference to the specification information. Then, the calculation part 13B calculates the transportation distance on the basis of the transportation destination place input by the user and the transportation source location of the assembly. Subsequently, the calculation part 13B calculates the transportation cost according to the transportation distance with reference to the table of transportation costs corresponding to the selected transportation means (S108). Further, the calculation part 13B calculates the delivery date of the assembly by converting the calculated assembly time into the number of days and adding the number of days to the longest or latest delivery date among the delivery dates of the components (S109). Thereafter, the estimation part 13D presents the assembly cost, the transportation cost, and the delivery date to the user by causing the terminal display part 46 to display the assembly cost, the transportation cost, and the delivery date as the estimation result (S110).

With the estimation system 100 according to the embodiment described above, when the user purchases the assembly constituted by assembling the plurality of components, the estimation result of the assembly cost can be provided to the user. Furthermore, the first rule and the second rule set for the components can be arbitrarily combined. Therefore, the degree of freedom in setting the calculation rule can be increased as compared with the case where the assembly time is calculated only from the specifications of the entire assembly. Thus, the calculation rule can be set so that the calculation accuracy becomes higher. For example, in order to prevent the assembly time from being redundantly added to one of the component groups attached in combination with each other, the first rule of “adding zero seconds” can be applied.

### Modification

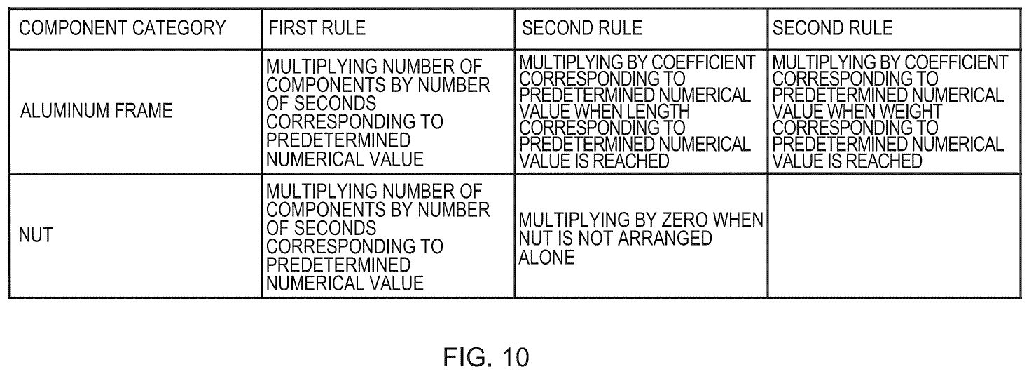

The first rule and the second rule illustrated in FIGS. 4 and 5 can be consolidated in one table. As an example, the table illustrated in FIG. 10 includes components of an aluminum frame and a nut. Then, the first rule of “multiplying the number of components by the number of seconds corresponding to the predetermined numerical value” is set for the aluminum frame and the nut. Furthermore, the second rule of “multiplying by the coefficient corresponding to the predetermined numerical value” is set for the aluminum frame belonging to the specification category of reaching the length corresponding to the predetermined numerical value. Further, for the aluminum frame belonging to the specification category of reaching the weight corresponding to the predetermined numerical value, the second rule of “multiplying by the coefficient corresponding to the predetermined numerical value” is set.

Further, the second rule of “multiplying by zero” is set for the nut belonging to the specification category that the nut is not arranged alone. Here, the classification of the specification category is defined by options of condition determination performed by the calculation part 13B. For example, the specification category is classified into an option of reaching the length corresponding to the predetermined numerical value and an option of not reaching the length corresponding to the predetermined numerical value. Then, there are the second rule of “multiplying by the coefficient corresponding to the predetermined numerical value” and the second rule of “not multiplying by the coefficient corresponding to the predetermined numerical value” for respective options. Even in such an aspect, the first rule and the second rule can be set for the components and be combined with each other.

Hitherto, the present invention has been described with reference to each embodiment, but the present invention is not limited to the above embodiments. Inventions modified within a range without contradictory to the present invention and inventions equivalent to the present invention are also included in the present invention. In addition, each embodiment and each modification can be appropriately combined within a range without contradictory to the present invention.

For example, the plurality of component categories may be classified into a component major category and a component minor category. That is, each component (for example, the square aluminum frame and the rectangular aluminum frame) may correspond to the component major category (for example, the aluminum frame). In this case, the first rule may be set for each component major category. As another example, the plurality of component major categories includes a panel and a nut. Then, the component minor categories belonging to the component major category of the panel are the bracket fastening type panel and the frame fastening type panel. Further, the component minor categories belonging to the component major category of the nut are the pre-insertion type nut and the post-insertion type nut. In this case, the first rule of “multiplying the number of components by the number of seconds corresponding to the predetermined numerical value” is set in the component major category of the nut.

Furthermore, the specification category may be classified for each component major category. As an example, the component major category of the panel is divided into a specification category of “using a pre-insertion nut” and a specification category of “not using a pre-insertion nut”. Then, the second rule of “multiplying by the coefficient corresponding to the predetermined numerical value” is set in the specification category of “using a pre-insertion nut”. Further, the second rule of “not multiplying by the coefficient corresponding to the predetermined numerical value” is set in the specification category of “not using a pre-insertion nut”. Furthermore, the component major category of the nut is divided into a specification category of “arranging the nut alone” and a specification category of “not arranging the nut alone”. Then, the second rule of “not multiplying by zero” is set in the specification category of “arranging the nut alone”. Further, the second rule of “multiplying by zero” is set in the specification category of “not arranging the nut alone”.

Further, all the components may be classified into the same specification category. For example, all the components may be classified into the specification category of “there is a match mark” or “there is no match mark” according to the specification information of “presence or absence of a match mark”. In this case, the second rule of “multiplying by the coefficient corresponding to the predetermined numerical value” is set in the specification category of “there is a match mark”. Further, the second rule of “not multiplying by the coefficient corresponding to the predetermined numerical value” is set in the specification category of “there is no match mark”.

Further, the calculation part 13B may calculate the assembly time in units of minutes, hours, or days instead of or in addition to seconds. Furthermore, the calculation part 13B may calculate the assembly time using arbitrary unit time, for example, a time for fastening one bolt as the unit time. In this case, when the time for fastening one bolt is 120 seconds, the assembly time of two minutes is one bolt fastening time.
13: server control part (computer)
13A: acquisition part (acquisition unit)
13B: calculation part (calculation unit)
13C: change part (change unit)
100: estimation system
PG: estimation program

1. An estimation system that estimates an assembly cost of an assembly constituted by assembling a plurality of components, the estimation system comprising:
an acquisition unit that acquires component specifying information for specifying components constituting the assembly from a component candidate group, and specification information for specifying a specification of the assembly constituted by the components specified by the component specifying information; and
a calculation unit that calculates, by using a predetermined calculation rule, the assembly cost in a case of assembling the assembly according to the specification specified by the specification information from each of components specified by the component specifying information, wherein
the calculation rule includes a first rule set for each of components of the component candidate group and a second rule set for at least one of the components of the component candidate group with respect to the specification information,
the second rule is set for each of specification categories classified into a plurality of specification categories according to the specification information,
the assembly is a frame body,
the components are frames constituting the frame body,
the specification information is at least one of a size or a weight of the frame body, and
the specification category corresponding to the size of the frame body includes a category of reaching a length corresponding to a predetermined numerical value and a category of not reaching the length corresponding to the predetermined numerical value, and the specification category corresponding to the weight of the frame body includes a category of reaching a weight corresponding to a predetermined numerical value and a category of not reaching the weight corresponding to the predetermined numerical value.

2. The estimation system according to claim 1, wherein the first rule is set for each of component categories classified into a plurality of component categories according to the component specifying information.

3. The estimation system according to claim 1, wherein
the calculation unit calculates the assembly cost by multiplying an assembly time of the assembly by a cost,
the first rule is set to calculate an assembly time of each of the components of the component candidate group, and
the second rule is set to correct an assembly time of the at least one component calculated using the first rule.

4. The estimation system according to claim 3, wherein at least one of the first rule or the second rule includes a condition rule part that designates a calculation condition and a numerical value rule part that designates a numerical value to be applied to calculation.

5. The estimation system according to claim 4, comprising:
a change unit that receives a setting change of the numerical value of the numerical value rule part, wherein
the calculation condition designated by the condition rule part is fixed.

6. An estimation system that estimates an assembly cost of an assembly constituted by assembling a plurality of components, the estimation system comprising:
an acquisition unit that acquires component specifying information for specifying components constituting the assembly from a component candidate group, and specification information for specifying a specification of the assembly constituted by the components specified by the component specifying information; and
a calculation unit that calculates, by using a predetermined calculation rule, the assembly cost in a case of assembling the assembly according to the specification specified by the specification information from each of components specified by the component specifying information, wherein
the calculation rule includes a first rule set for each of components of the component candidate group and a second rule set for at least one of the components of the component candidate group with respect to the specification information,
the second rule is set for each of specification categories classified into a plurality of specification categories according to the specification information, and
the calculation unit further calculates a transportation cost of the assembly with reference to the specification information corresponding to the second rule set for a basic component among the components constituting the assembly.

7. An estimation program of an estimation system that comprises a computer and estimates an assembly cost of an assembly constituted by assembling a plurality of components, the estimation program causing the computer to function as:
an acquisition unit that acquires component specifying information for specifying components constituting the assembly from a component candidate group, and specification information for specifying a specification of the assembly constituted by the components specified by the component specifying information; and
a calculation unit that calculates, by using a predetermined calculation rule, the assembly cost in a case of assembling the assembly according to the specification specified by the specification information from each of components specified by the component specifying information, wherein
the calculation rule includes a first rule set for each of components of the component candidate group and a second rule set for at least one of the components of the component candidate group with respect to the specification information, and
the second rule is set for each of specification categories classified into a plurality of specification categories according to the specification information,
the assembly is a frame body,
the components are frames constituting the frame body,
the specification information is at least one of a size or a weight of the frame body, and
the specification category corresponding to the size of the frame body includes a category of reaching a length corresponding to a predetermined numerical value and a category of not reaching the length corresponding to the predetermined numerical value, and the specification category corresponding to the weight of the frame body includes a category of reaching a weight corresponding to a predetermined numerical value and a category of not reaching the weight corresponding to the predetermined numerical value.

8. An estimation program of an estimation system that comprises a computer and estimates an assembly cost of an assembly constituted by assembling a plurality of components, the estimation program causing the computer to function as:
an acquisition unit that acquires component specifying information for specifying components constituting the assembly from a component candidate group, and specification information for specifying a specification of the assembly constituted by the components specified by the component specifying information; and
a calculation unit that calculates, by using a predetermined calculation rule, the assembly cost in a case of assembling the assembly according to the specification specified by the specification information from each of components specified by the component specifying information, wherein
the calculation rule includes a first rule set for each of components of the component candidate group and a second rule set for at least one of the components of the component candidate group with respect to the specification information,
the second rule is set for each of specification categories classified into a plurality of specification categories according to the specification information, and
the calculation unit further calculates a transportation cost of the assembly with reference to the specification information corresponding to the second rule set for a basic component among the components constituting the assembly.

9. A control method for an estimation system that comprises a computer and estimates an assembly cost of an assembly constituted by assembling a plurality of components, the control method comprising the steps of:
acquiring, by the computer, component specifying information for specifying components constituting the assembly from a component candidate group, and specification information for specifying a specification of the assembly constituted by the components specified by the component specifying information; and
calculating, by the computer by using a predetermined calculation rule, the assembly cost in a case of assembling the assembly according to the specification specified by the specification information from each of components specified by the component specifying information, wherein
the calculation rule includes a first rule set for each of components of the component candidate group and a second rule set for at least one of the components of the component candidate group with respect to the specification information,
the second rule is set for each of specification categories classified into a plurality of specification categories according to the specification information,
the assembly is a frame body,
the components are frames constituting the frame body,
the specification information is at least one of a size or a weight of the frame body, and
the specification category corresponding to the size of the frame body includes a category of reaching a length corresponding to a predetermined numerical value and a category of not reaching the length corresponding to the predetermined numerical value, and the specification category corresponding to the weight of the frame body includes a category of reaching a weight corresponding to a predetermined numerical value and a category of not reaching the weight corresponding to the predetermined numerical value.

10. A control method for an estimation system that comprises a computer and estimates an assembly cost of an assembly constituted by assembling a plurality of components, the control method comprising the steps of:
acquiring, by the computer, component specifying information for specifying components constituting the assembly from a component candidate group, and specification information for specifying a specification of the assembly constituted by the components specified by the component specifying information; and
calculating, by the computer by using a predetermined calculation rule, the assembly cost in a case of assembling the assembly according to the specification specified by the specification information from each of components specified by the component specifying information, wherein
the calculation rule includes a first rule set for each of components of the component candidate group and a second rule set for at least one of the components of the component candidate group with respect to the specification information,
the second rule is set for each of specification categories classified into a plurality of specification categories according to the specification information, and
the computer further calculates a transportation cost of the assembly with reference to the specification information corresponding to the second rule set for a basic component among the components constituting the assembly.
